(19) United States
(12) Patent Application Publication
(10) Pub. No.: US 2002/0096859 A1
(43) Pub. Date: Jul. 25, 2002

(54) Motorcycle trailer hitch

(76) Inventor: Douglas W. Versaw, Golden, CO (US)

Correspondence Address: J. MARK SMITH, PITTENGER & SMITH, P.C., 3010 EAST 6TH AVENUE, DENVER, CO, 80206, US

(21) Appl. No.: 09/767,891

(22) Filed: Jan. 22, 2001

(51) Int. Cl. B60D 1/00

(52) U.S. Cl. 280/511; 280/400

(57) ABSTRACT

The present invention relates to an assembly for a trailer hitch for motorcycles that allows for easy attachment and an unobtrusive profile. The hitch assembly includes two (2) support ribs connected to the motorcycle frame and a cross piece to which a ball hitch is attached. The hitch assembly attaches to the frame of the motorcycle, regardless of whether the rear fender is a bob tail, a conventional fender or a low retro style; whether the wheel is a fat tire or not; and whether there are side bags or turn signals or not. The hitch assembly does not use supports mounted to the exterior of the wheel or hub. Further the hitch assembly in some embodiments can be installed such that it is not visible except for the ball hitch hanging down from the particular fender far enough to attach and detach a trailer tongue. In one embodiment the ball hitch is removably attached. The invention also addresses the potential height disparity between the ball hitch and the trailer tongue.

### FIELD OF THE INVENTION

The present invention relates to an assembly for a trailer hitch for motorcycles that allows for easy attachment of the hitch and an unobtrusive profile. The invention addresses both the hitch assembly on the motorcycle and the potential height disparity between the ball and the trailer tongue.

### BACKGROUND OF THE INVENTION

Motorcycle enthusiasts are concerned about maintaining the clean lines and classic form of their vehicles. Motorcyclists take pleasure in the freedom and exhilaration that riding the highways bring. Trailers are occasionally needed or wanted to carry extra gear, such as for traveling or camping. Towing a trailer with a motorcycle is well known. However, to enable the attachment of a trailer, a hitch must be mounted to the motorcycle. Unfortunately, such hitches detract from the flowing lines and sleek impression of the motorcycle.

Prior means for attaching hitch assemblies to a motorcycle have generally been to secure such hitches to the frame, rear struts, rear hub, or other substantial support location, or to a combination of these locations, by an exterior tube frame with bolts and nuts. The mounting process often requires significant disassembly of components or removal of the rear wheel. This is a major undertaking and thus, once such hitches are installed, they are not easily removed and become de facto permanent extensions to rear wheel and fender assemblies. As the majority of time a motorcycle is used it is not pulling a trailer, the unused hitches become unsightly, undesirable accessories.

These hitches, which are quite prominent and highly visible, generally extend rearward from the attachment points on the motorcycle around the rear wheel and/or fender in a yoke-like form. They are even more unsightly and incongruous with bob tail or short fender motorcycles. Common hitches extend significantly beyond and below the fender. For low fender configurations, hitches must wrap around the fender to reach supportive attachment points and are therefore very obvious and unsightly as well.

### SUMMARY OF THE INVENTION

The object of the present invention is to provide a trailer hitch for a motorcycle which does not detract from the aesthetics of the fender and rear end of the motorcycle. In one embodiment, the attachment points for the trailer hitch are located inside and underneath the rear fender. This allows the hitch assembly to be nested under and inside the rear portion of the fender as well and thus it is not readily visible. In other configurations, such as with fat tires where there is little extra room under the fender, the attachment points may be on the outside of the rear fender, however the hitch is designed to follow the contours of and blend with the fender.

Specifically the hitch assembly attaches to the frame horn of the motorcycle as it rises up over the rear wheel. The hitch assembly is compatible with multiple fender styles such as conventional, bob tail, or a low retro style. Further, the hitch assembly may be designed to accommodate saddle bags and turn signals as well. Notably, the hitch assembly does not attach to or require support from the wheel or hub.

In the case of a motorcycle with a short or “bobtail” fender, the connection of the hitch to the tongue of a trailer may be assisted through the use of a goose neck extension. The goose neck extension allows for proper attachment between the trailer and the motorcycle at the ball hitch or other hitching mechanism point by keeping the trailer tongue at the proper height such that the trailer maintains a level orientation. In other types of fenders, the assembly places the ball hitch at the right height.

In an alternate embodiment of an under the fender hitch, the ball hitch or other hitching mechanism can be removed when not in use, thereby masking any external appearance of a trailer hitch assembly as it is hidden under the fender. In this version, the ball hitch is removably attached to the trailer hitch assembly by a pin and lock pin assembly. When not in use, the ball hitch is removed, leaving only the original fender visible.

### BRIEF DESCRIPTION OF THE DRAWINGS

FIG. 1 is a perspective view of one version of a motorcycle hitch assembly for a bobtail style fender with top notches to accommodate turn signals.

FIG. 2 is a perspective, cut-away view of the rear of a motorcycle with a version of the hitch assembly for a bobtail style fender installed inside of the fender.

FIG. 3 is a perspective view of the rear of a motorcycle with a version of the hitch assembly for a bobtail style fender installed inside of the fender.

FIG. 4 is a perspective view of a second version of a motorcycle hitch assembly with a removable ball hitch.

FIG. 5 is a perspective, cut-away view of a second version of a motorcycle hitch assembly with a removable ball hitch installed inside of the fender.

FIG. 6 is a perspective view of a second version of a motorcycle hitch assembly with a removable ball hitch installed inside of the fender.

FIG. 7a is a side view of a motorcycle with the hitch assembly installed and the trailer attached.

FIG. 8 is a perspective view of a hitch assembly such as, shown in FIG. 7.

### DETAILED DESCRIPTION OF THE INVENTION

The rear fender 26 of a motorcycle, as shown for example in FIG. 1, is generally mounted to both the two fender struts 30 and the frame horn 28. The frame horn 28 is that part of the motorcycle frame which extends behind the seat and up and over the rear wheel. As the frame horn rises, it splits like a yoke with two members spaced apart across the width of the wheel. The fender 26 is normally mounted on the interior of the frame horn 28, between these yoke members of the frame horn 28, and the fender struts 30 are mounted on the exterior of the frame horn 28, one on each side of the motorcycle. The fender struts 30 can be chrome-plated pieces which cover the structural steel of the frame horn 28. The fender 26 and the fender struts 30 are bolted to the frame horn 28 by bolts running through all three, sandwiching them together.

The frame horn 28 does not extend all the way to the end of the fender 26 or back of the wheel. The fender struts 30 and fender 26 are generally attached to the frame horn 28 by several bolts closer to the seat. The fender 26 and fender struts 30 may be further connected by additional bolts where these parts extend beyond the tip of the frame horn 28.

The subject invention is a trailer hitch assembly 10 for a motorcycle which attaches to the normal frame horn 28/fender 26/fender strut 30 assembly. The trailer hitch assembly 10 is attached to the frame horn 28 at least one point. The frame horn 28 provides the primary support for the towing capacity of the trailer hitch assembly 10. The hitch assembly 10 may be attached to the frame horn 28 with the same bolts or other common fasteners used to attach the fender 26 and fender struts 30.

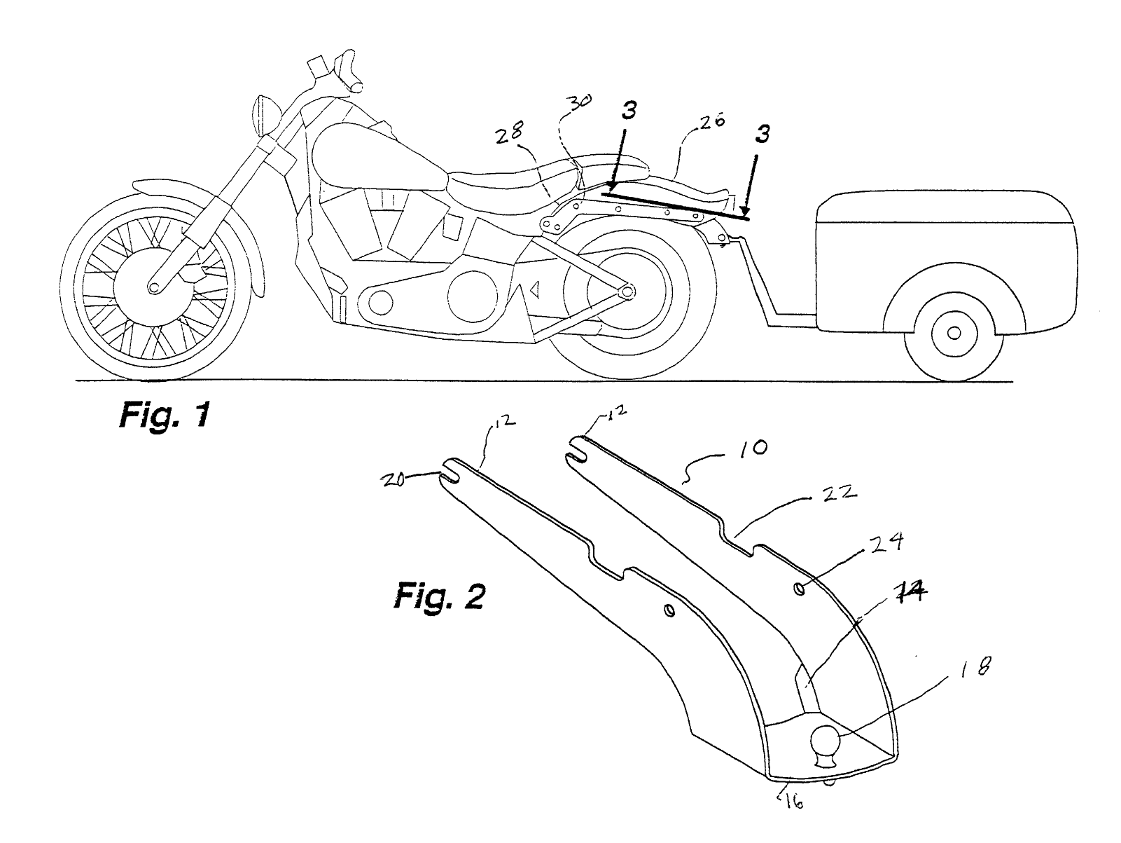

FIG. 2 shows a first embodiment of the present invention and FIG. 1 shows the invention in practical application on a motorcycle. The motorcycle trailer hitch assembly 10 is comprised of two (2) substantially parallel side ribs 12 for attaching to the frame horn 28 and fender struts 30 of the motorcycle. At the rear most part of the hitch assembly 10 is a hitch base 16 to which a ball hitch 18 or other hitching mechanism is installed to mate with the tow bar attachment means of a trailer. The hitch assembly 10 may be made from structural steel or other suitable material that is able to withstand the vibration and weight bearing of the towing of motorcycle trailers.

The hitch base 16 may be an extension of the side ribs 12, and thus of unitary construction, or of separate construction incorporating a cross piece welded to each side rib 12 or attached by any suitable means such as rivets, removable pins, bolts or screws. FIG. 2 shows additional support for the hitch base 16 in the form of welded corner supports 14.

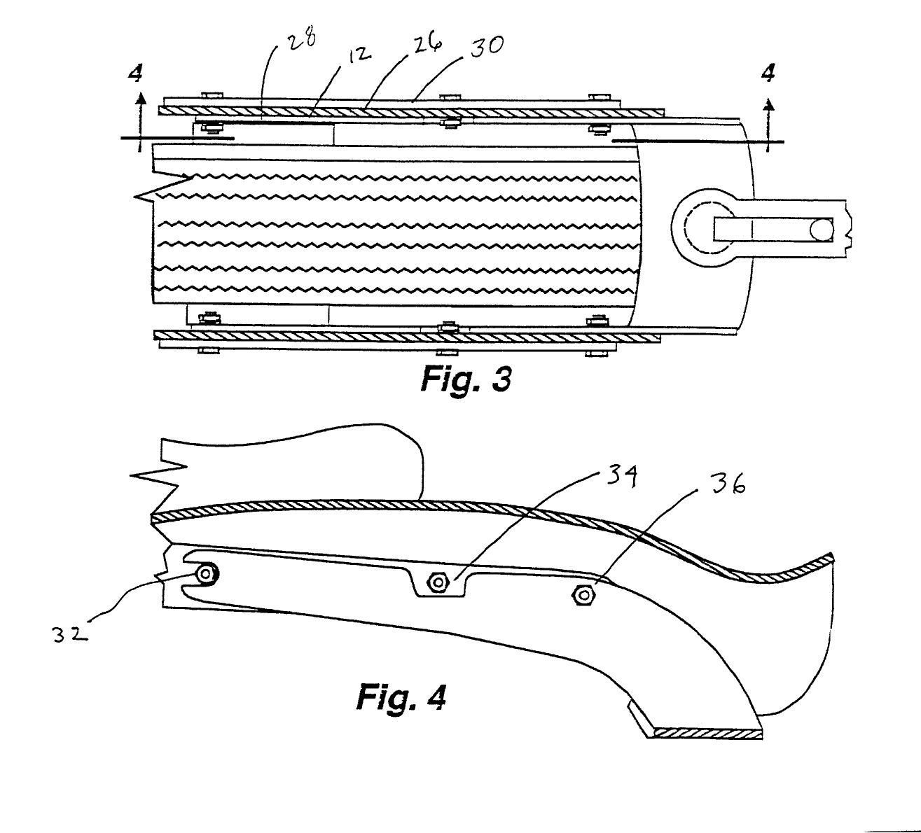

The hitch assembly 10 of this first embodiment may be mounted either underneath the fender 26 or on the outside of the fender 26 on top of the fender strut 30. FIG. 1 shows a side view of the rear of a motorcycle incorporating an under the fender 26 hitch assembly 10. FIG. 3 shows a top view, with the top of the fender 26 and fender strut 30 cut away to expose the frame horn 28, the side rib 12, the fender 26 and the fender strut 30. In the depicted configuration, the fender strut 30 on one side of the motorcycle is connected to the frame horn 28 and the fender 26 by six standard bolts. The hitch assembly 10 is attached by utilizing three of the five bolts already present on the motorcycle.

The hitch assembly 10 of FIG. 2 includes a forward notch 20 for each side rib 12 which fits around and engages the corresponding bolt shaft at the frame bolt position 32 as in FIG. 4. This bolt is already used to attach the fender 26 and fender strut 30 to the frame horn 28 at the frame bolt position 32. This same attachment would occur on the opposite side of the motorcycle with the second side rib 12. The forward notch 20 is formed such as to slip around the bolt at the frame bolt position 32 into a space between the head of the bolt and the underside of the fender 26 for an internal mount, or between the fender strut 30 and the nut on the bolt in an external application, when the bolt is loosened. It is intended that the bolt need not be entirely removed, but merely that the forward notch 20 be slipped into the spacing created when the bolt is loosened.

The top notch 22 in each of the side ribs 12 is similarly attached either underneath the fender 26 or on top of the fender strut 30 depending on preference at tail light position 34 sliding top notch 22 into a similar spacing, created when the bolts at tail light positions 34 are loosened. This is again done without the necessity of removing the bolts. The top notches 22 may be wide enough as in FIG. 1 to accommodate in a fender strut 30 mounting, in addition to the bolts, side turn signal supports and their wiring that are sometimes installed at tail light position 34. For motorcycles without side turn signals in tail light position 34, the top notches 22 may be more narrow to merely fit around the bolts as in FIG. 4.

In some configurations for side turn signals, the side turn signal supports may fully invoke the use of the bolts at tail light position 34. In this case, the rear-most bolt connecting the fender 26 and fender strut 30 at strut bolt position 36 should be used to support the hitch assembly 10. For this purpose, there is a rear hole 24 within in each side rib 12, aligned with strut bolt position 36 for attachment at that point. Ideally, in all installations of the hitch assembly 10, the rear hole 24 will be bolted to the fender 26 and fender strut 30 for added support. A hole rather than a notch is used in the hitch assembly 10 at the strut bolt position 36 to provide added stability to the mounting system of the hitch assembly 10. Although this may require the entire removal of a bolt, this is not a major undertaking because the bolt at the strut bolt position 36 is easily accessible at the end of the fender 26 and the frame horn 28 does not extend this far.

On some motorcycles, the fender strut 30 may not extend the full length of the fender 26 and therefore the hitch assembly 10 may be merely attached to the fender 26 at strut bolt position 36. This attachment to the fender 26 may be accomplished with suitable common attachment means, including bolts with lock nuts or other anti-loosening means.

As noted, the first embodiment of the hitch assembly 10 can be mounted on the inside of the fender 26 as in FIG. 2 or on the outside of the fender strut 30. When the side ribs 12 are mounted inside the fender 26, other than the hitch base 16 and the ball hitch 18, no portion of the hitch assembly 10 is readily visible (See FIG. 1). When the side ribs 12 are mounted on the fender strut 30 they may be made to match the width, color and form of the fender strut 30 so as to easily blend with the natural look and lines of the motorcycle.

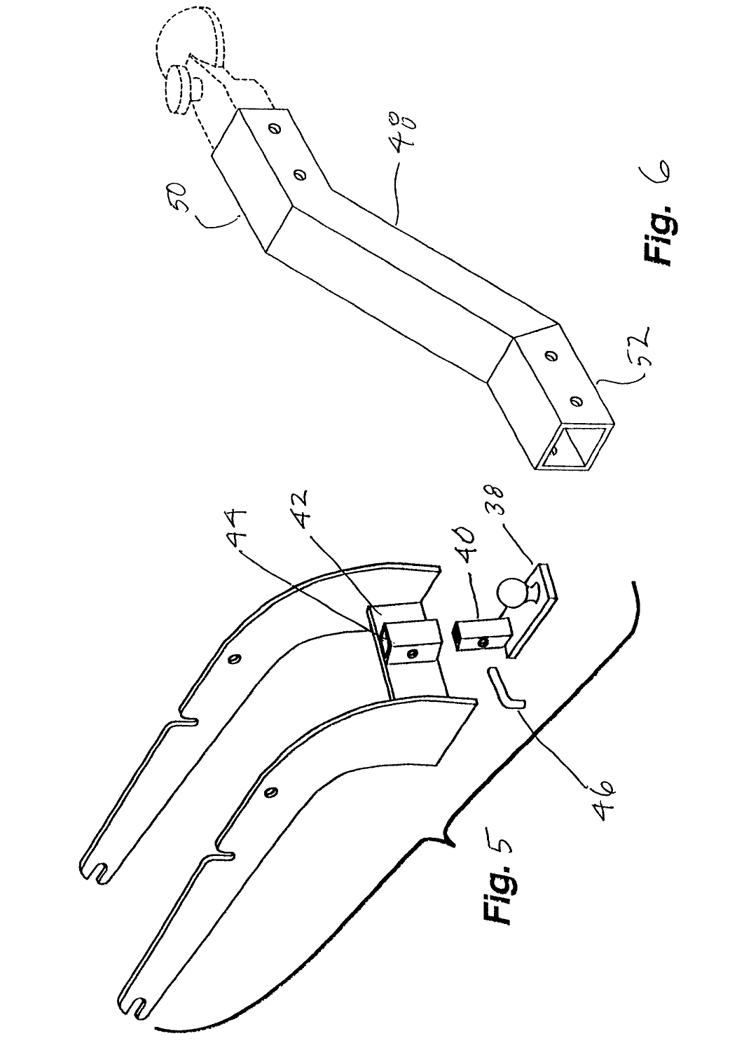

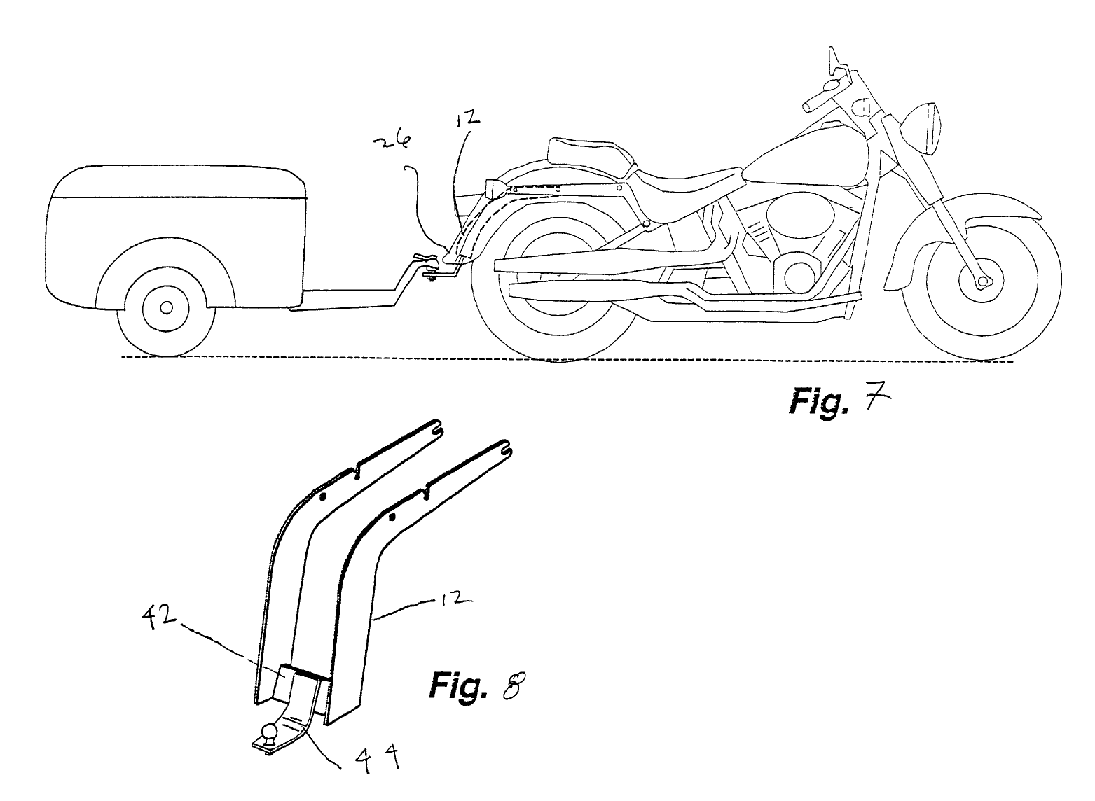

The second embodiment of the hitch assembly as shown in FIG. 5 incorporates a removable hitch base 38. This embodiment would generally be used in an inside the fender 26 configuration on motorcycles with conventional or low retro-style fenders 26 (see FIG. 7). When not in use, the hitch base 38 can be easily removed and the hitch assembly 10 would not be readily viewable as it is substantially hidden under the fender 26 as seen in FIG. 5. The removable hitch base 38 is not limited, however, to longer fenders, and may also be used with short bobtail fenders of the type in FIGS. 5 and 1.

For conventional fenders 26 as in FIG. 7, the side ribs 12 of the hitch assembly 10, FIG. 8, are longer than shown in the first embodiment of FIG. 2, with the rear portion extending and curving downward further behind the rear wheel to reach to the lowest point of the tail of the fender 26. For low retro-style fenders, the side ribs 12 must be longer and extend even further as in FIGS. 7 and 8.

To accommodate a removable hitch base, the hitch assembly incorporates a vertical hitch plate 42 instead of a horizontal hitch base 16. The hitch plate 42 may be an extension of the side ribs 12, and thus of unitary construction, or of separate construction incorporating a cross-piece welded to each side rib 12 or attached by any suitable means such as rivets, removable pins, bolts or screws. Mounted on the hitch plate 42 is a hitch plate mount 44, which in the preferred embodiment is of square channel steel construction well known in the industry. One side of the square channel hitch plate mount 44 is attached to the hitch plate 42 in a vertical orientation.

Upon the removable hitch base 38 is similarly mounted a hitch base mount 40 of square channel steel construction. One end of the hitch base mount 40 is attached to the removable hitch base 38 such that the square channel of the hitch base mount 40 rises in a vertical orientation. The hitch plate mount 44 and the hitch base mount 40 may be attached to the hitch plate 42 and removable hitch base 38, respectively, via conventional such as with bolts, pins 46 or other fasteners, or if permanency is desired, via riveting, welding or other assembly.

The square channel of the hitch base mount 40 is of slightly shorter perimeter such that it may easily slide into the square channel of the hitch plate mount. The removable hitch base 38 can then be securely connected to the hitch plate via one or more bolts, pins 46 or other similar attachment means. When the removable ball mount 38 is attached as shown in FIG. 5, it extends down below the tail of the fender, FIG. 1, and is available for attachment to the ball socket on the tongue of the trailer, FIG. 1. When not in use, removal of the removable hitch base 38 results in the remainder of the hitch assembly being hidden from view under the fender 26.

In installations on bobtail fender 26 motorcycles such as in FIGS. 2 and 3, the ball hitch 18 may be significantly higher than the ball socket on the tongue of the trailer. Generally, the trailer tongue should be kept level with the ground to maintain a good connection between the ball hitch 18 and the ball socket and prevent the rear of the trailer from scraping the ground. In order to attach the tongue of the trailer to the ball hitch 18 and maintain a strong connection and freedom of turning and movement, an extension piece 48 such as in FIG. 6 may be needed.

In a preferred embodiment, the extension piece 48, as shown on FIG. 6, is of square channel steel construction well known in the industry. The lower end 52 connects to the tongue. The upper end 50 then attaches to the ball socket for normal connection with the ball hitch 18. Attachment means between the lower end 52 and the tongue of the trailer are conventional such as with bolts, pins 46 or other fasteners, or if permanency is desired, via riveting, welding or other assembly. The angle of incline of the gooseneck extension 48 is an acute angle, preferably between 30 and 60 degrees (30°-60°), and the length and height may vary depending on the particular combination of motorcycle and trailer.

I claim:

1. A trailer hitch assembly for a motorcycle comprising:
a) elongated first side member which removably attaches to one side of the rear frame of the motorcycle;
b) a second side member which removably attaches to the opposite side of the rear frame;
c) a cross member surface that connects the first and second side members at the rear end of the first and second sides; and
d) a hitch mechanism attached to the cross member for removable connection with and towing of a trailer.

2. A trailer hitch assembly as set forth in claim 1 wherein the hitch mechanism is removably attached to the cross member.

3. A trailer hitch assembly of claim 1 where the hitch mechanism is attached to the trailer by an extension piece.

4. The assembly of claim 1 where the side pieces fit inside the fender.

5. The assembly of claim 1 where the side pieces fit outside of the fender.

6. The assembly of claim 1 where the hitch mechanism is a ball hitch.

7. An extension piece for attaching a hitch mechanism on a motorcycle to a trailer tongue to keep the tongue relatively horizontal comprising:
a) an extension piece with a front attachment and a rear attachment;
b) the front attachment having a removable connection for the hitch mechanism on the motorcycle;
c) the rear attachment connectable to the tongue of the trailer;
d) where the height difference when installed between the front and rear connectors equals the height difference between the front hitch on the motorcycle and the tongue on the trailer.
